(19) United States
(12) Patent Application Publication
(10) Pub. No.: US 2012/0236835 A1
(43) Pub. Date: Sep. 20, 2012

(54) METHOD AND SYSTEM FOR RECORDING A GEOGRAPHICAL LOCATION FROM A MOBILE COMMUNICATION DEVICE

(75) Inventors: Daniel S. Rokusek, Long Grove, IL (US); Kevin M. Cutts, Lake Zurich, IL (US); Hai Ding, Buffalo Grove, IL (US); Stephen H. Shaw, Rochester, NY (US)

(73) Assignee: MOTOROLA MOBILITY, INC., Libertyville, IL (US)

(21) Appl. No.: 13/047,265

(22) Filed: Mar. 14, 2011

(51) Int. Cl. H04W 24/00; H04W 84/02

(52) U.S. Cl. 370/338; 455/456.1; 455/457

(57) ABSTRACT

A method for recording a geographical location from a docked mobile communication device that includes detecting a mobile communication device communicatively coupled to a docking device; and detecting that the mobile communication device is communicatively uncoupled from the docking device. Afterwards, the geographical location of the mobile communication device is recorded and stored in memory upon detecting that the mobile communication device has communicatively uncoupled from the docking device.

### FIELD OF INVENTION

The invention disclosed herein is related to recording a geographical location using a mobile communication device. More particularly, the invention relates to using a location or positioning system such as the global positioning system (GPS), or Global Navigation Satellite System (GLONASS), or Beidou Satellite Navigation System, or a wireless local area networking system (WLAN and WiFi) or other equivalent systems and services, in cooperation with a triggering or initializing mechanism to automatically store a geographical location as determined by a mobile communication device.

### BACKGROUND OF INVENTION

Conventional geographical location applications for mobile communication devices typically reside in the processor of the mobile communication device after having been downloaded to the mobile communication device. To operate the geographical location applications, a user of the mobile communication device must manually open the application each time the user desires to know her geographical location. In addition, a user has to remember to open the application to initialize or trigger the searching function of the geographical location application. Afterwards, a user has to select or command the geographical location application to retain the found geographical location. The aforementioned scenario can be inconvenient for a mother handling several small children in a large shopping complex parking lot.

As a result, additional innovation is needed to provide a method and system for recording a geographical location from a mobile communication device.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary flowchart;

FIG. 2 is an exemplary flowchart;

FIG. 3 is an exemplary flowchart;

FIG. 4 is an exemplary flowchart;

FIG. 5 is an exemplary flowchart;

FIG. 6 is a block diagram for an exemplary system according to the present invention;

FIG. 7 is a block diagram for an exemplary docking device that includes a security chipset;

FIG. 8 is a block diagram for an exemplary mobile communication device;

FIG. 9 is a block diagram for an exemplary computer server;

FIG. 10 is a working example of a screenshot taken from a mobile communication device;

FIG. 11 is a second working example of a screenshot taken from a mobile communication device; and

FIG. 12 is an illustration of an exemplary docking device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method for recording a geographical location from a docked mobile communication device includes detecting whether a mobile communication device is communicatively coupled to a docking device; and also detecting that the mobile communication device has been communicatively uncoupled from the docking device. Finally, the method records the geographical location of the mobile communication device in stored memory. Notably, the method can employ the global positioning system (GPS), or Global Navigation Satellite System (GLONASS), or Beidou Satellite Navigation System, or a wireless local-area networking standard (WLAN), such as the 802.11 family that use the same basic protocols, including 802.11b, 802.11g, 802.11n (Wi-Fi), or other equivalent systems or services to determine location and position of the mobile communication device.

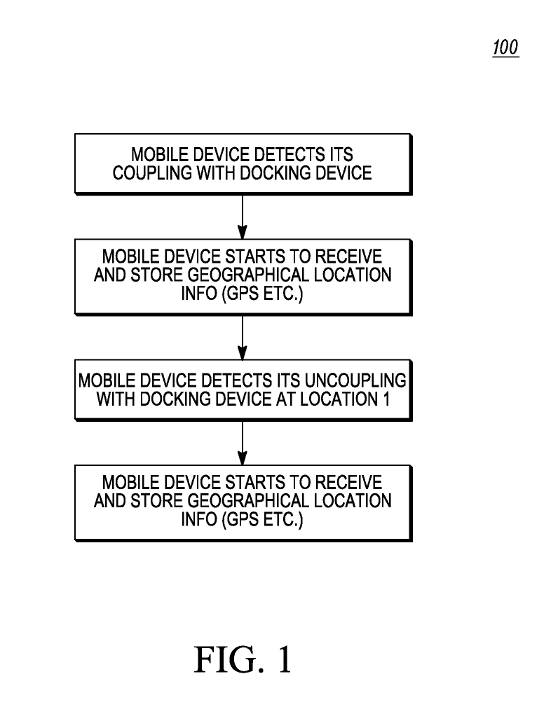

FIG. 1 is a flowchart 100 that shows exemplary steps or operations. For example, operation 110 enables the mobile communication device to detect whether it has communicatively coupled to a docking device. The coupling of the mobile communication device can be a physical coupling or alternatively it can be a wireless communication coupling using for example infrared or Bluetooth technology. The docking device is generally thought of as a cradle for the mobile communication device, however, it may simply be a physical apparatus of any shape that is linked to or is communicatively coupled to the mobile communication device. An authentication chip or chipset within the docking device can ensure that security and proper communication protocols have been correctly established. Although not shown in FIG. 1, yet is readily understood by those skilled in the mobile communications industry, a central processor may be part of the mobile communication device to handle more complicated operations.

Operation 120 illustrates that the mobile communication device begins to receive and store initial geographical location information or data. This operation can be accomplished by using the global positioning system (hereinafter referred to as GPS). In addition, the initial geographical location data can be also determined from the mobile communication device's accelerometer. A gyroscope on the mobile communication device may also provide geographical location data. Alternatively, the gyroscope, accelerometer, and GPS may work in combination with each other to provide geographical location data.

Operation 130 illustrates that the mobile communication device detects its uncoupling from the docking device at a first location. The uncoupling can be a physical separation from the docking device or can be a de-establishing operation that communicatively breaks the link with the docking device. The decoupling can be given by voice command or manual input on a user interface of the docking device. The process of decoupling the mobile communication device from the docking device establishes a first location where the decoupling happens.

Operation 140 illustrates the recording and storage of the first location subsequent to the decoupling process. The mobile device can record and store the data associated with the positioning of the first location locally in the memory of the mobile communication device, or alternatively the mobile communication device can transmit the data to a remote server for storage. One or more of the above operations may be repeated or performed in other embodiments of the invention. Accordingly, they will be labeled the same for consistency and clarity. Additional operations may be included as well, for example, notifying a user that a geographical location has been stored. The notification may comprise a textual notification, using one or more LEDs, an auditory output, a background color change for the display, a wallpaper change for the display or a haptic vibratory operation. Those skilled in the art recognize that this list is not exhaustive, but is illustrative that several notifications have been contemplated are equivalent in their purpose of alerting a user to the recordation and presence of geographical location information resulting from an uncoupling of the mobile communication device from the docking device.

An additional operation that may be employed is that of erasing the geographical location from the stored memory. This operation may sometimes be referred to as ‘flushing the memory’. The flushing of the memory may occur manually or automatically as determined by an elapsed time period or occurrence of a specified event, such as the recoupling of the mobile communication device to the docking device after an uncoupling event has been detected.

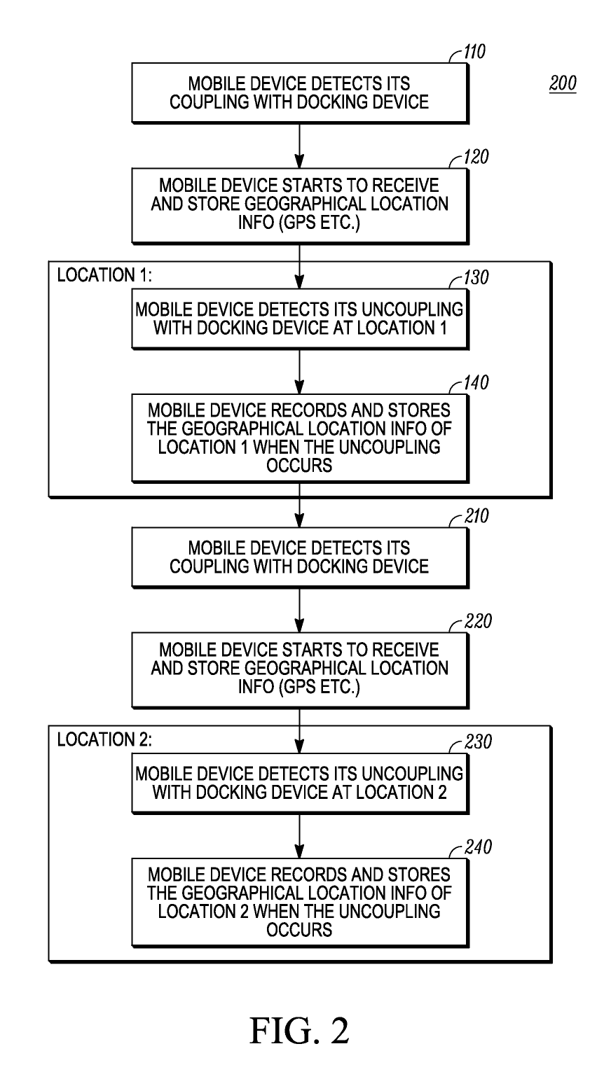

FIG. 2 depicts another embodiment that includes all of the operations in FIG. 1 for a first location; therefore, description for these operations will not be repeated for the description of FIG. 2. Nevertheless, FIG. 2 includes additional operations beyond those depicted in FIG. 1. Beginning with operation 210, the mobile communication device detects a second coupling with a docking device. The coupling process and the docking device can be as described earlier for FIG. 1. Upon the second coupling, operation 220 enables the mobile communication device to begin receiving and storing initial and transient geographical location. This can be accomplished by GPS, for example. Alternatively, other sources for determining geographical location can be incorporated, including an accelerometer, a gyroscope, and a wireless router.

Operation 230 illustrates that the mobile communication device detects its uncoupling from the docking device at a second location different from the first location. The uncoupling can be a physical separation from the docking device or can be a de-establishing operation that communicatively breaks the link with the docking device. The decoupling can be given by voice command or manual input on a user interface of the docking device. The process of decoupling the mobile communication device from the docking device establishes a second location where the decoupling happens. The difference between the first location and the second location can be determined, for example, by using distance measurements, elapsed time, or some combination of the two.

Operation 240 illustrates the recording and storage of the second location subsequent to the decoupling process. The mobile device can record and store the data associated with the positioning of the second location locally in the memory of the mobile communication device, or alternatively the mobile communication device can transmit the data to a remote server for storage.

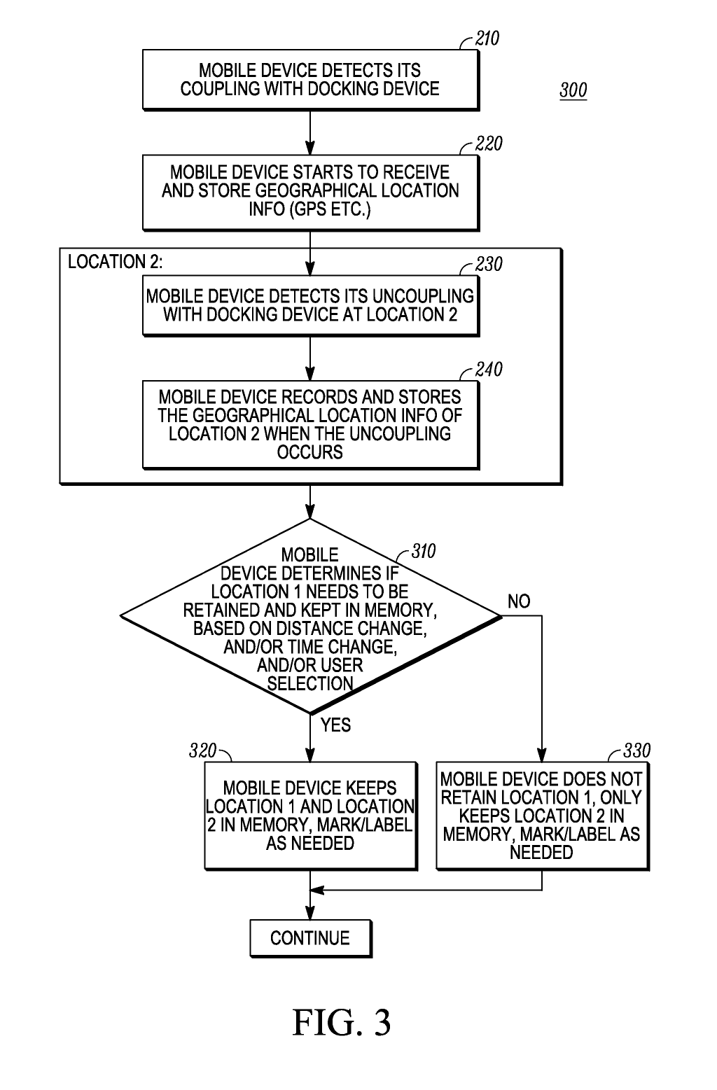

Regarding FIG. 3, flowchart 300 includes operations 210-240 of FIG. 2 with respect to the processes affected by a second geographical location. In addition, operation 310 includes a decision by the mobile device's processor to determine whether the first geographical location should be retained in memory or storage. This decision can be based on predefined parameters such as a change in distance over a set threshold, a change in elapsed time, or a mobile device's selection via manual input or voice command. If the decision is made to store the first geographical location, then operation 320 enables the mobile device to retain the first and the second geographical location in memory. The first and second geographical locations are also labeled or marked for easy reference by the mobile communication device user.

Alternatively, operation 310 may result in a decision not to retain the first geographical location in memory. Consequently, operation 330 retains only the second geographical location. The second geographical location is labeled or marked for easy reference by the mobile communication device user.

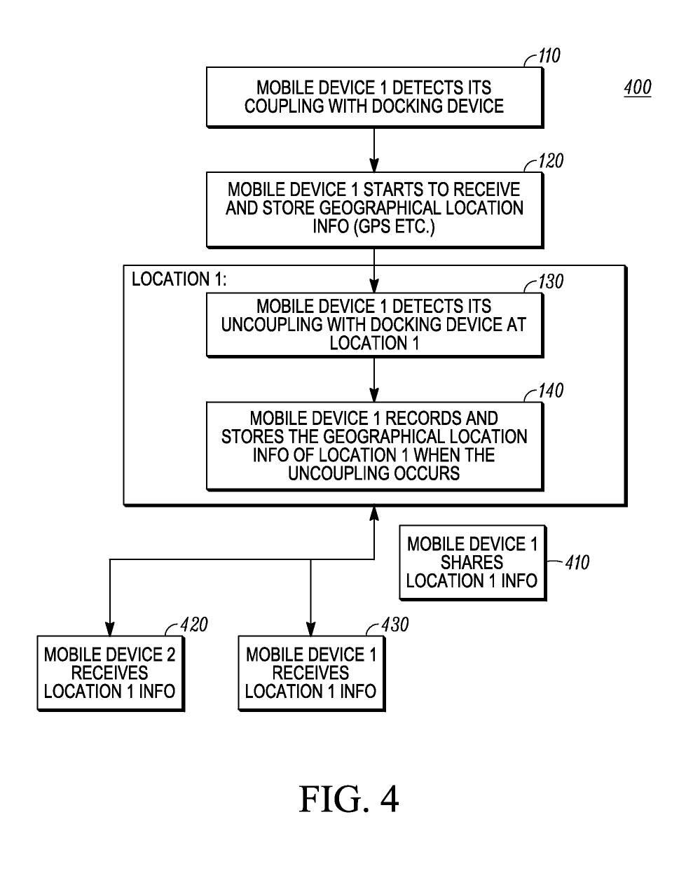

Regarding FIG. 4, flowchart 400 includes operations 110-140 of FIG. 1 with respect to the processes affected by a first geographical location. Operation 410 processes a command to share the first geographical location. The command can be a voice command or manual input to a user interface of the mobile communication device. The sharing of the geographical location data can be to a second mobile communication device, as is illustrated in FIG. 4; but the sharing can also be to a desktop computer or a server.

As exemplarily shown in FIG. 4, operation 420 controls a second mobile communication device, different, from the first mobile communication device that recorded and stored the geographical location data corresponding to a first geographical location. Operation 420 controls the second mobile communication device to receive, from the first mobile communication device, the geographical location data corresponding to a first geographical location. Likewise, several mobile communication devices can be instructed to receive the geographical location data corresponding to a first geographical location. Operation 430 controls these additional mobile communication devices to receive the geographical location data corresponding to a first geographical location.

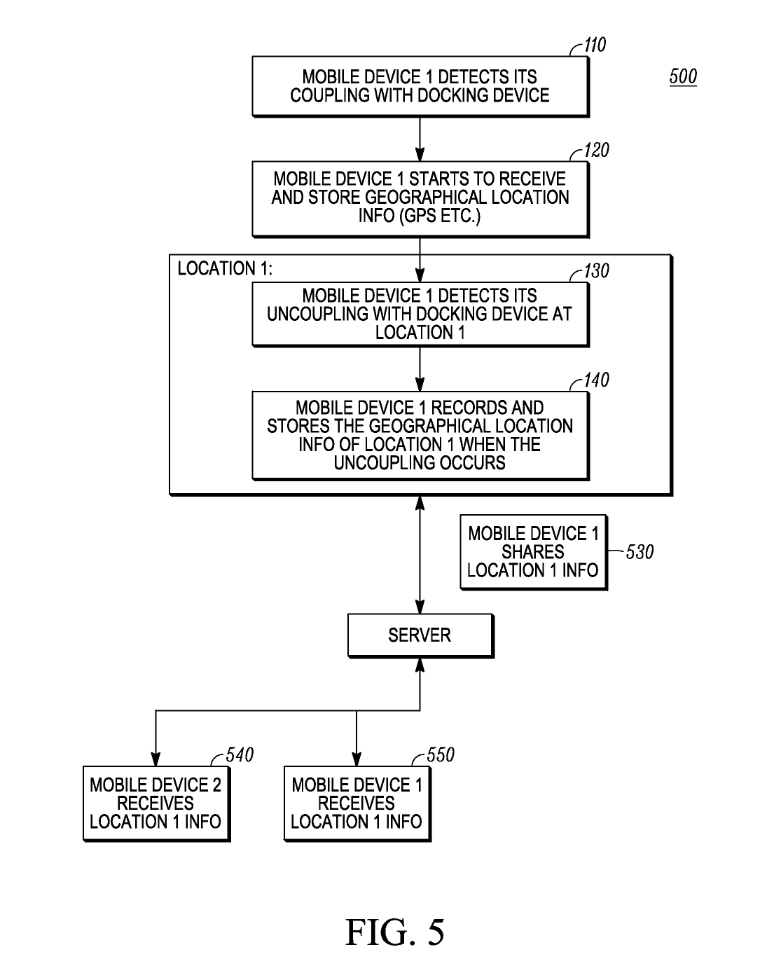

Referring to FIG. 5, flowchart 500 includes operations similar to operations 110 and 120 shown and described earlier for FIG. 1. At an unknown location, hereinafter referred to as location (i), operation 510 enables a mobile communication device 1 to detect whether it has uncoupled communicatively from a docking device at location (i). Once the uncoupling of mobile communication device 1 from the docking device happens, operation 520 enables mobile communication device 1 to record and store the geographical location data associated with location i.

Operation 530 enables the mobile communication device 1 to share its geographical location data about location i with a server or network. In operation 540, a second mobile communication device, mobile communication device 2, receives the geographical location data about location i. Similarly, other mobile communication devices, herein referred to as mobile communication device I, may also receive the geographical location data about location i.

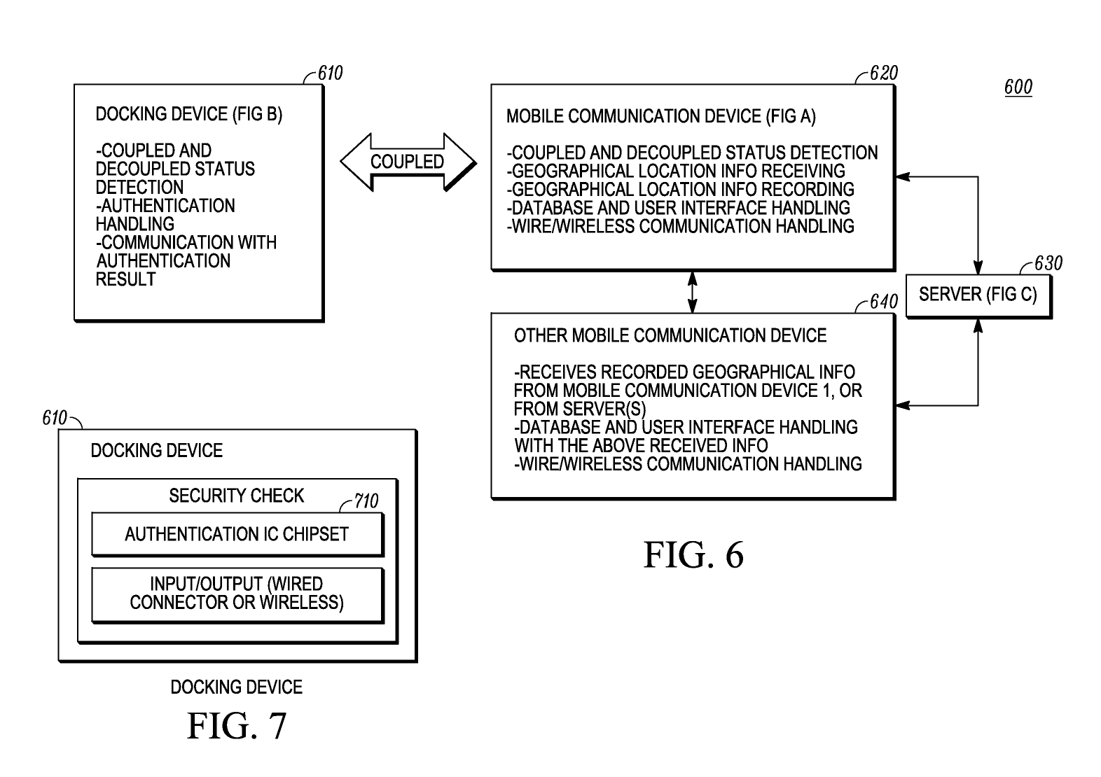

Referring to FIG. 6, an exemplary machine in the form of a computer system 600 is shown in block diagram form. A set of instructions, when executed, may cause the machine to perform any one or more of the methodologies described above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in server-client user network environment, or as a peer machine in a peer-to-peer (or distributed) network environment.

The machine may comprise a server computer, a client user computer, a personal computer (PC), a tablet PC, a personal digital assistant, a portable phone on a wireless or cellular network, a laptop computer, a smartphone either alone or combined with a display device, a control system, a network router, or any machine capable of executing a set of instructions (sequential or otherwise) that specify actions to be taken by that machine, not to mention a mobile server. It will be understood by those ordinarily skilled in the art of mobile communication devices and associated networks, either wired or wireless that the mobile communication device described herein includes broadly any electronic device that provides voice, video, and data communication. Further, while a single machine is illustrated, the term “machine” shall also be taken to include any collection of machines that individually or jointly executed a set (or multiple sets) of instructions to perform any one or more methodologies discussed herein.

A docking device 610 is coupled or decoupled to a mobile communication device 620. Docking device is further illustrated in FIG. 7. Docking device 610 may include status detection for determining whether the docking device has been actually coupled or decoupled from mobile communication device 620. Docking device 610 may include authentication handling via an authentication chipset. Any likely communication from docking device 610 may also include the authentication result from authentication chipset 710 shown in FIG. 7.

Mobile communication device 620, as shown in FIG. 6, may be in communication with a server 630 or another mobile communication device 640. Alternatively, mobile communication device 620 may be in communication with a server 630 and another mobile communication device 640. Several programs may reside on mobile communication device 620, including detecting coupling and decoupling with docking device 610; updating status detection associated with coupling and decoupling with docking device 610; receiving geographical location information or data; recording geographical location information or data; handling database data and user interface manipulation; handling wired and wireless communication. Likewise, the other mobile communication device 640 may have similar programs residing in its processor.

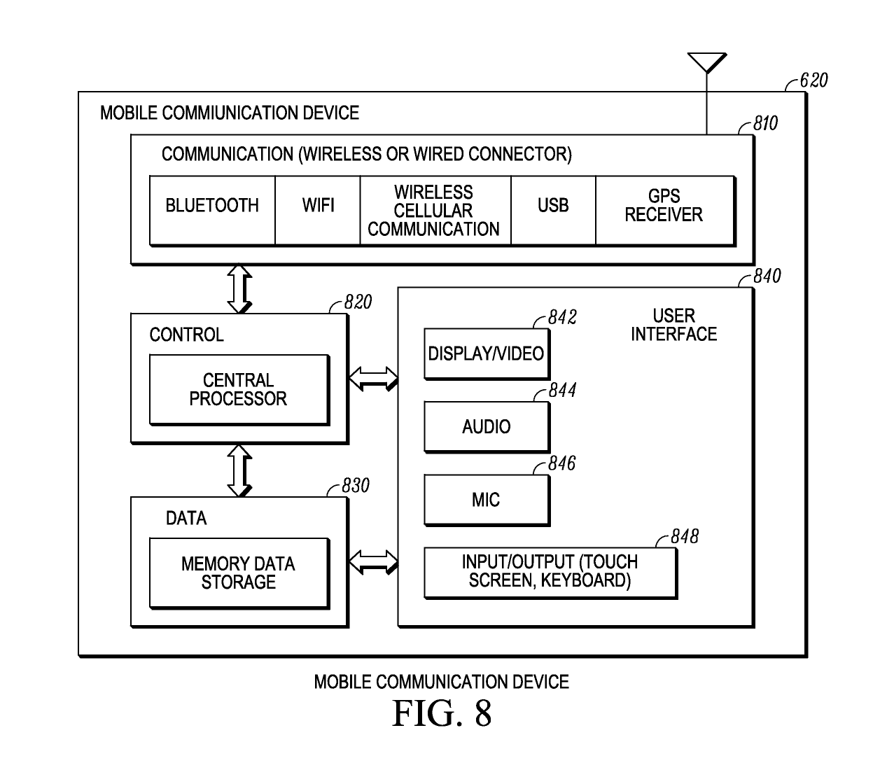

Mobile communication device 620 is further illustrated by example in FIG. 8, and may include a communication module 810 communicatively coupled to a control module 820. Control module 820 is shown as communicatively coupled to a data module 830 and a user interface module 840. The communication module 810 may have a wireless or a wired connector, as well. Accordingly, communication module can be capable of receiving and sending signals compatible with Bluetooth, WIFI, wireless cellular communication, USB, or may include a GPS receiver.

The control module 820 includes a central processor capable of running operations programs for the mobile communication device 620. Data module 830 includes a memory data storage unit capable of retaining and erasing geographical location information. The user interface module 840 shown in FIG. 8 may include a display 842 for still and moving images; an audio outlet 844, for example one or more speakers and an audio jack; a microphone 846 for voice input; and a user manual input 848 that can be a touchscreen or a keyboard or both.

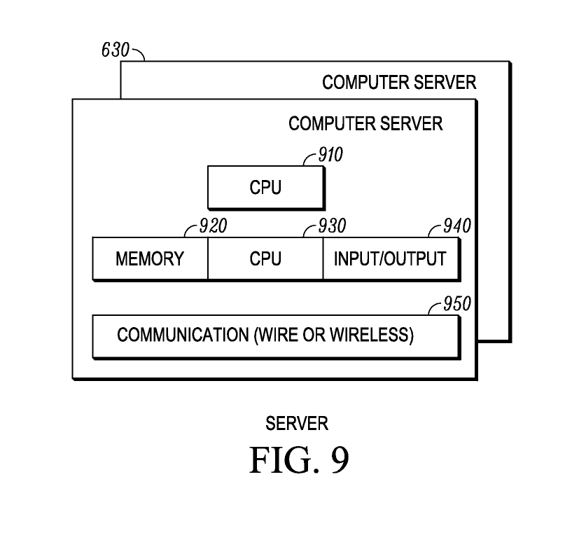

FIG. 9 shows an exemplary server 630 that includes several of the same components shown in FIG. 8 for the mobile communication device 620. As such, server 630 can handle like data traffic, associated with geographical locations, in a similar manner as mobile communication device 620. Specifically, server 630 includes a central processing unit, CPU 910 communicatively coupled to a memory module 920, a data module 930, an input/output module 940; and a communication module 950 that may be further include a wired or wireless connector.

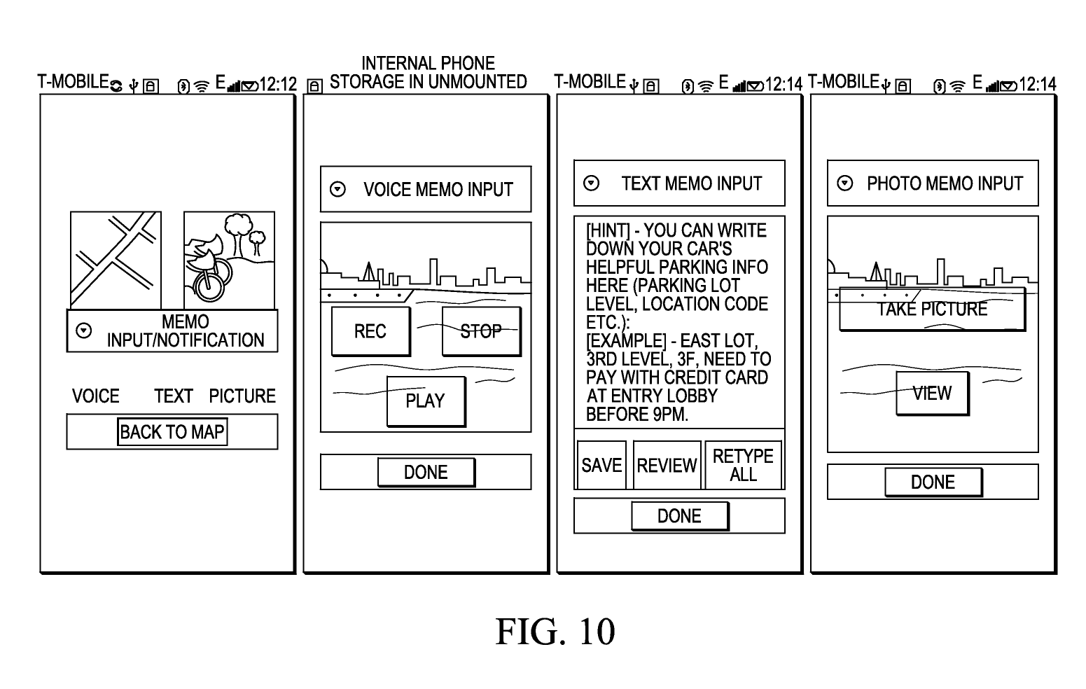

FIG. 10 illustrates different examples of memos that may be employed by the user and that may be offered by the mobile communication device. The memos enable the user to provide further details about the recorded geographical location that can assist the user in remembering or finding their way back to the recorded geographical location once they move a great distance from the geographical location. For example the user of the mobile communication device may select either a voice memo, a text memo, or a picture memo.

A voice memo associated with the mobile communication device enables a user to record an auditory message as an input to the mobile communication device and play the recorded message as an output of the mobile communication device. Examples of auditory messages are the user's own voice, the ambient sounds of the geographical location (e.g., a train whistle, a church bell, children playing), or an official's voice (e.g., ticket agent, toll booth operator, police officer).

A text memo associated with the mobile communication device enables a user to record a textual message as an input to the mobile communication device. The text memo may include a detailed description of the geographical location, such as when the user writes down a parking garage location that includes a floor level, a parking space designator, and a color of an elevator door, along with payment options.

A picture memo associated with the mobile communication device enables a user to record an image as an input to the mobile communication device. The image may be a still or a moving image. As such, the image can comprise JPEG, JPEG2000, MPEG, MPEG4, GIF, TIFF, or other well-known image formats. The user may input a picture of the near surroundings of the recorded geographical location, such as landmarks, items of interest, local eateries, or persons associated with the geographical location (e.g, traffic officer, street vendors, street musicians).

The optional memos voice, text, and picture are displayed as part of a user interface for the mobile communication device. Additional information may be appended to the memos as well, for example, a time stamp, region information such as county, state, or city information. When the user desires to retrieve the recorded geographical location the memo information with the user's detailed information is retrieved along with geographical location information such as distance, directional information, sonar-like sounds having different frequencies for indicating a target location, and GPS data.

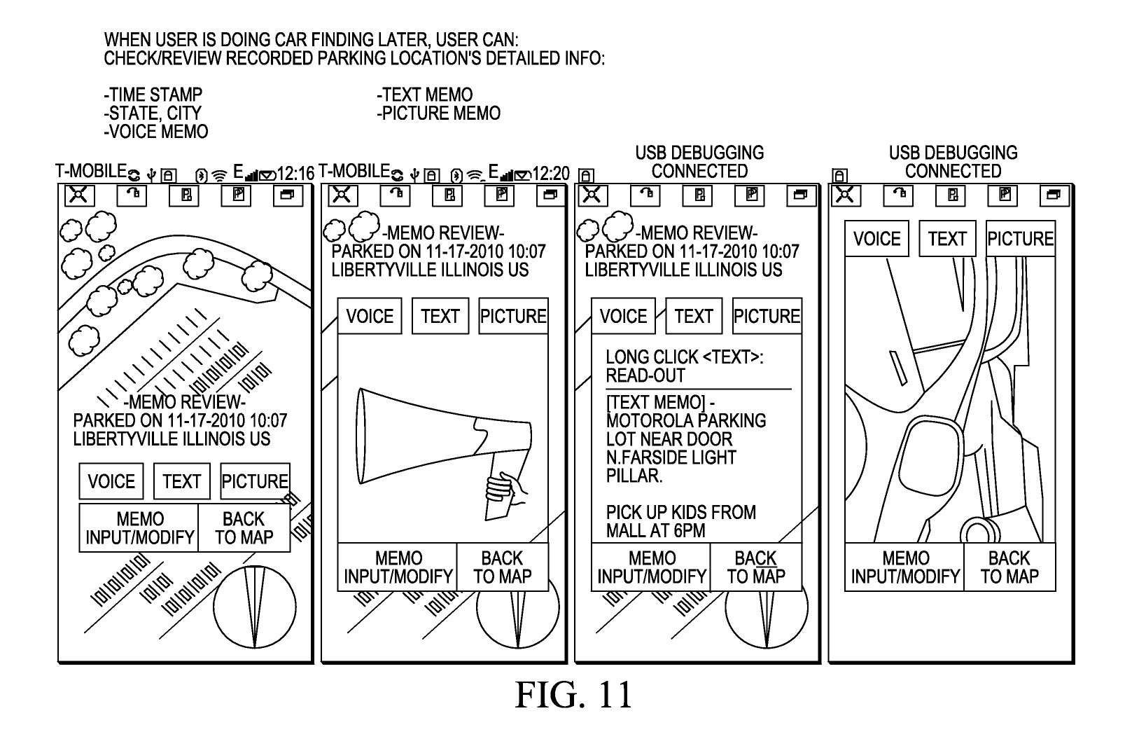

FIG. 11 exemplarily illustrates several user interface screen shots of retrieved geographical location information and memo information associated with a large parking lot where a prototypical user has parked her car and has uncoupled her mobile communication device from a docking device within her car prior to exiting her car. Optional voice, text, and picture memos provide information in different forms to the user, but all aid the user in that the user selected the memo information that would be most relevant to her.

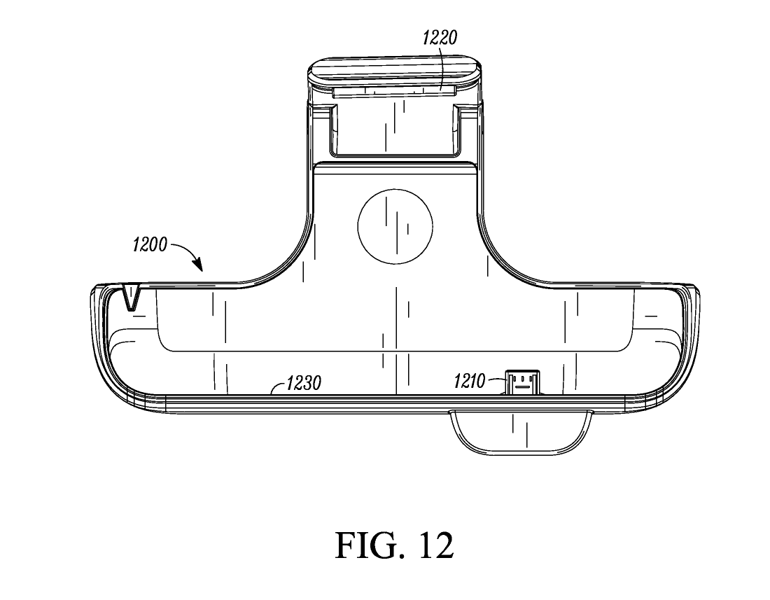

FIG. 12 illustrates an exemplary docking device 1200. Docking device 1200 includes an electro/mechanical connector 1210 that enables transfer of communication protocols and data and charging of the mobile communication device. Electro/mechanical connector 1210 is equipped to detect the presence or non-presence of the mobile communication device. Electro/mechanical connector may be a universal serial bus (USB), for example, or an equivalent communication interface.

Docking device 1200 also includes a latch 1220 that holds the mobile communication device within a cradle of docking device 1200. A rest 1230 provides additional support for the mobile communication device when it resides in a crade of the docking device 1200. The docking device 1200 may be employed in a vehicle such as an automobile, bus, van, boat, or it may be configured to adaptively fit on a motorcycle or a bicycle, for example.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions or code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a non-transitory machine readable storage device or medium having computer readable code stored thereon for programming a computer (e.g., comprising a processor) to perform a method as described and claimed herein. Examples of such non-transitory machine readable storage devices or mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for recording a geographical location from a docked mobile communication device, comprising the steps of:
detecting a mobile communication device communicatively coupled to a docking device;
detecting that the mobile communication device is communicatively uncoupled from the docking device; and
recording the geographical location of the mobile communication device in stored memory upon detecting that the mobile communication device has communicatively uncoupled from the docking device.

2. The method claimed in claim 1, further comprising determining the geographical location via a global positioning system.

3. The method claimed in claim 1, further comprising determining the geographical location via a local positioning system.

4. The method claimed in claim 3, wherein the local positioning system is a wireless local area networking system.

5. The method claimed in claim 1, wherein the step of detecting that the mobile communication device is communicatively uncoupled to the docking device includes determining a physical removal of the mobile communication device from the docking device.

6. A method for recording a plurality of geographical locations from a docked mobile communication device, comprising the steps of:
detecting a mobile communication device communicatively coupled to a docking device;
detecting that the mobile communication device is communicatively uncoupled to the docking device;
recording a first geographical location of the mobile communication device in stored memory;
at a second geographical location:
detecting a mobile communication device communicatively coupled once again to a docking device;
detecting that the mobile communication device is once again communicatively uncoupled to the docking device;
recording a second geographical location of the mobile communication device in stored memory; and
determining whether to retain the first geographical location when a second geographical location has been stored in memory.

7. The method claimed in claim 6, further comprising the steps of:
determining distance traveled by the mobile communication device; and
determining time elapsed in order to determine whether to retain the first geographical location.

8. The method claimed in claim 7, further comprising labeling the second location once the first location has been retained.

9. The method claimed in claim 1, wherein the recorded geographical location is shared amongst a plurality of mobile communication devices.

10. The method claimed in claim 1, wherein the docking device is associated with a vehicular transportation means.

11. The method claimed in claim 1, wherein the recorded geographical location is shared amongst a plurality of display devices.

12. The method claimed in claim 1, further comprising the step of erasing the geographical location from the stored memory when the mobile communication device has been recoupled to the docking device.

13. A system of a geographical location finder on a mobile communication device, comprising:
a communication module;
a control module, communicatively coupled to the communication module, and further comprising a processor programmed to:
detect the mobile communication device has communicatively coupled to a docking device; and
detect that the mobile communication device has communicatively uncoupled from the docking device;
a data module, communicatively coupled to the control module, and enabled to record the geographical location of the mobile communication device in stored memory upon detection that the mobile communication device has communicatively uncoupled from the docking device; and
a user interface module communicatively coupled to the control module; wherein the user interface module provides a notification of the recorded geographical location to a display on the mobile communication.

14. The system of claim 13, wherein the system further comprises a docking device having an authentication chipset.

15. The system of claim 13, wherein the system further comprises a computer server including a memory module, a data module, a central processor, and a communication module; all communicatively coupled to each other within the computer server.

16. A non-transitory machine readable storage, having stored thereon a computer program having a plurality of code sections comprising:
code for detecting a mobile communication device communicatively coupled to a docking device;
code for detecting that the mobile communication device is communicatively uncoupled from the docking device; and
code for recording the geographical location of the mobile communication device in stored memory upon detecting that the mobile communication device has communicatively uncoupled from the docking device.

17. A non-transitory machine readable storage, having stored thereon a computer program having a plurality of code sections comprising:
code for detecting a mobile communication device communicatively coupled to a docking device;
code for detecting that the mobile communication device is communicatively uncoupled to the docking device;
code for recording a first geographical location of the mobile communication device in stored memory;
at a second geographical location:
code for detecting a mobile communication device communicatively coupled once again to a docking device;
code for detecting that the mobile communication device is once again communicatively uncoupled to the docking device;
code for recording a second geographical location of the mobile communication device in stored memory; and
code for determining whether to retain the first geographical location when a second geographical location has been stored in memory.
